(19) United States
(12) Patent Application Publication
(10) Pub. No.: US 2006/0043041 A1
(43) Pub. Date: Mar. 2, 2006

(54) Portable crane

(76) Inventor: Edmund Lopes, La Jolla, CA (US)

Correspondence Address: William P. Glenn, Jr., Suite 205, 2102 Mechanic Street, Galveston, TX, 77550, US

(21) Appl. No.: 10/931,098

(22) Filed: Aug. 31, 2004

(51) Int. Cl. B66C 23/26

(52) U.S. Cl. 212/175

(57) ABSTRACT

A portable crane having a boom with a mid-section disposed between a load section and a counter-weight section. An operator seat assembly is connected to the counter-weight section. A sheave is fixed to the load section distal to the counter-weight section. A winch is fixed to the boom. A wire with two ends is spooled onto the winch with the first end securely attached to the wind and the second end fairlead over the sheave and attached to a lifting device. The lifting device can be a hook, thimbled eye or shackle. In a preferred embodiment, a bi-pod wheel assembly is connected to and below the mid-section. The bi-pod wheel assembly includes an axle perpendicular to the boom and has at least two wheels in rolling contact with a flat surface.

### TECHNICAL FIELD

This invention relates generally to material handling devices. More particularly, it relates to portable cranes. Portable cranes using operator weight to counter-balance a load are easy to transport, assembly, use and disassemble.

### BACKGROUND ART

In general, those who are in need to lift and slew a load from above use rope or wire reeved through a block suspended overhead, chain falls slidably fixed on I-beams, come-alongs temporarily rigged to surrounding structures or truck mounted cranes. However each of these lifting and stewing methods present a number of challenges for individuals looking to handle a load quickly, inexpensively and safely. Blocks, chain falls and come-alongs all require a secure overhead point to secure the lifting apparatus. Sometimes such a point is not conveniently located or even present. Truck mounted cranes are capable of overcoming these challenges by suspending (and slewing) the securing point overhead by means of a boom. However, such truck mounted cranes are limited to situations or locations where the truck and boom can safely maneuver. Furthermore, truck mounted cranes can require a significant amount of time to rig and de-rig. Additionally, truck mounted cranes can be expensive to own or rent.

The portable crane disclosed in K. Shirley's U.S. Pat. No. 5,224,612 is an attempt to address these issues. However, the Shirley portable crane requires a long lever arm and a guy cable to suspend and slew a load. Such a long lever arm is not useful in confined areas. Furthermore, the weight of the load is limited by the upper body strength of the operator. The present novel portable crane provides a means to suspend and slew loads of greater weight and/or in smaller areas than the Shirley portable crane by mounting the operator onto the boom to act as a counterweight. The present novel invention further enables an operator to adjust the portable crane to meet his/her physical requirements.

These enhancements are benefits are described in greater detail herein below with respect to several alternative embodiments of the present invention.

### SUMMARY OF THE INVENTION

This invention includes features and components that have been invented and selected for their combined benefits and superior performance as poured-in-place lightweight concrete walls and horizontal components. Each of the individual components work in association with the others and are optimally mated for superior performance.

Referring now to specific embodiments of the novel portable crane and several of its applications in the material handling business, additional benefits and advantageous features will be appreciated. One embodiment of the present invention is a portable crane having a boom with a mid-section disposed between a load section and a counter-weight section. An operator seat assembly is connected to the counter-weight section. A sheave is fixed to the load section. A winch is fixed to the boom. A wire with two ends is spooled on the winch with the first end securely attached to the winch and the second end fairlead over the sheave and attached to a lifting device. The lifting device can be a hook, thimbled eye or a swivel. A wheel assembly is connected to and below the mid-section. The wheel assembly includes an axle perpendicular to the length of the boom and has at least two wheels in rolling contact with a flat surface.

In one embodiment, the boom is segmented so that it can be broken down into smaller sections for ease of transport. Similarly in another embodiment, the wheel assembly is removable from the boom for ease of transport. In other embodiments, telescopic joints are contained within the various sections to vary the length of the boom, the height of the boom above the flat surface and the position of the operator's seat on the boom.

In all its embodiments, the present invention allows an operator to use his/her weight rather than upper body strength or a long lever arm to lift a load. Furthermore the present invention allows a quick assembly with interchangeable parts to fit the needs of the operator. This can be quite useful when a load need to be moved between the ground and a roof top. The low overhead profile, unlike that of the Shirley portable crane, allows material handling to occur in areas where there is restricted overhead clearance or clear floor space.

Among the benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### BRIEF DESCRIPTION OF THE DRAWINGS

The invention will now be described in greater detail in the following way of example only and with reference to the attached drawings, in which:

FIG. 1 is a perspective view of a portable crane in use.

FIG. 2 is a perspective view of a portable crane with an adjustable wheel assembly.

FIG. 3 is a perspective view of another embodiment of a portable crane with telescopic joints.

FIG. 4 is a perspective view of a sectional portable crane.

FIG. 5 is a perspective view of a sectional portable crane with an adjustable wheel assembly and an adjustable counter-balance section.

FIG. 6 is a perspective view of another sectional portable crane.

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

Furthermore, elements may be recited as being “coupled”; this terminology's use anticipates elements being connected together in such a way that there may be other components interstitially located between the specified elements, and that the elements may be connected in fixed or movable relation one to the other.

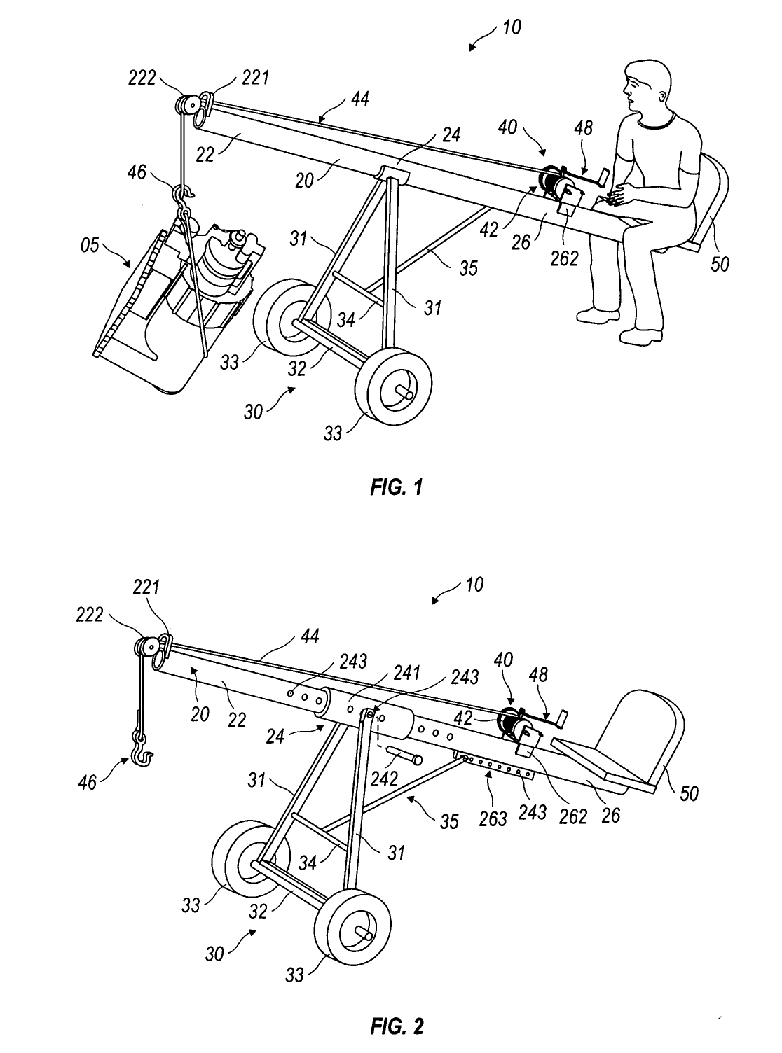

Referring to FIGS. 1 through 3, a portable crane 10 includes a boom 20 with a mid-section 24 disposed between a load section 22 and a counter-weight section 26. An operator seat assembly 50 is connected to the counter-weight section 26. A sheave 222 is fixed to the load section 22. A winch 40 is fixed to the boom 20. A wire 44 with two ends is spooled onto the winch 40. The first end of the wire 44 is securely attached to the winch drum 42. The second (or free) end of the wire 44 is fairlead over the sheave 222 and attached to a lifting device 46. A wheel assembly 30 is connected to and below the boom 20 so that the wheels 33 are in rolling contact with a flat surface (not shown).

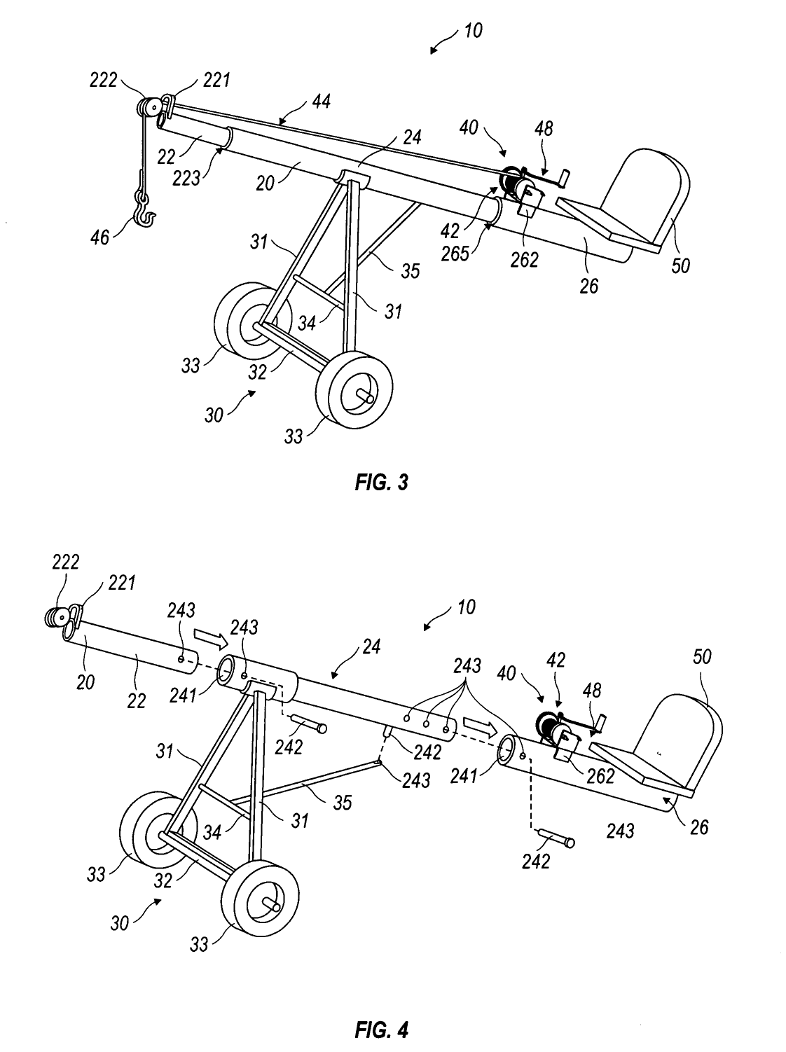

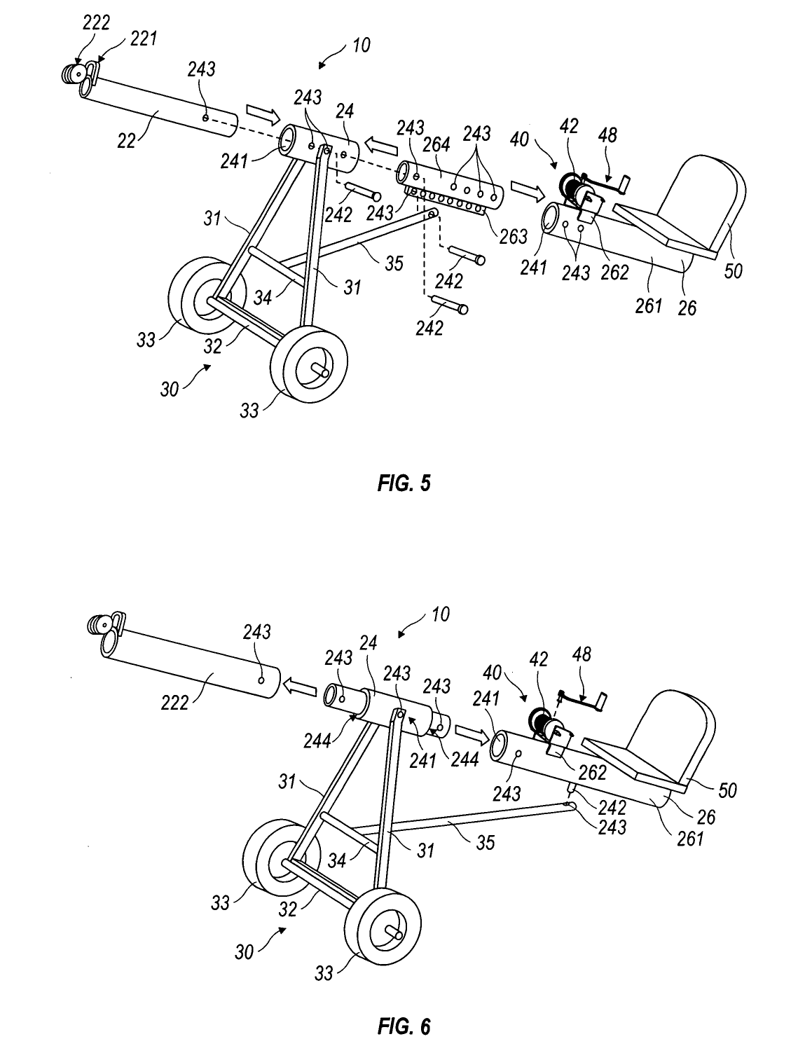

In another embodiment, load section 22 is removably fixed to the mid-section 24. (See FIGS. 4-6). Removable fixation of a load section 22 to a mid-section 24 can be achieved in a variety of ways. As shown in FIGS. 4 and 5, mid-section 24 includes a receiver 241 by which an end portion of a load section 22 fits. Securing the connection between the mid-section 24 and load section 22 is achieved by placing pins 242 through adjacently aligned holes 243. The pins 242 can be threaded and secured by a nut (not shown) or secured by a cotter pin arrangement (not shown). In another embodiment, the end portion of a load section 22 is slid over an end portion of the mid-section 24 until it rests against a shoulder 244 (See FIG. 6). As described above, securing the connection between the mid-section 24 and load section 22 is achieved by placing pins 242 through adjacently aligned holes 243. The pins 242 can be threaded and secured by a nut (not shown) or secured by a cotter pin arrangement (not shown). In another embodiment, load section 22 includes a telescopic joint 223 disposed between the sheave 222 and the mid-section 24 (See FIG. 3). The telescopic joint 223 allows the length of the boom 10 to be adjusted according to the operator's requirements.

All of the embodiments of the load section 22 described above allow the portable crane 10 to be transported in smaller components to the job site. This is especially helpful when the portable crane 10 must be used on a rooftop. The sectionalization of the boom 10 further allows the operator to change out different length load sections 22 thereby changing the reach (and load capacity) of the boom 20. Similarly, a telescopic joint 223 fitted into load section 22 allows the length of a boom 20 to be varied to meet the operational requirements of a confined space.

Referring to FIGS. 4 through 6, counter-weight section 26 is removably fixed to the mid-section 24. Removable fixation of a counter-weight section 26 to a mid-section 24 can be achieved in a variety of ways. As shown in FIGS. 4 and 6, the end portion of a mid-section 24 is slid over an end portion of a counter-weight 26 until it rests against a shoulder 244 fixed on mid-section 24. Securing the connection between the mid-section 24 and counter-weight section 26 is achieved by placing pins 242 through adjacently aligned holes 243. The pins 242 can be threaded and secured by a nut (not shown) or secured by a cotter pin arrangement (not shown). In another embodiment, a sleeve 265 slides into a receiver 241 formed in the mid-section 24 and second receiver 241 formed in the counter-weight section 26. Securement of the sleeve 265 to the mid-section 24 and the counter-weight section 26 is achieved by placing pins 242 through adjacently aligned holes 243 formed in the mid-section 24, sleeve 265 and counter-weight section 26 (See FIG. 5). As described above, securing the connections between the mid-section 24 and sleeve 265 and sleeve 265 and counter-weight section 26 are achieved by placing pins 242 through adjacently aligned holes 243. The pins 242 can be threaded and secured by a nut (not shown) or secured by a cotter pin arrangement (not shown). In another embodiment, counter-weight section 26 includes a telescopic joint 265 disposed between the operator seat 50 and the mid-section 24 (See FIG. 3).

All of the embodiments of the counter-weight section 26 described above allow the portable crane 10 to be transported in smaller components to the job site. This is especially helpful when the portable crane 10 must be used on a rooftop. The sectionalization of the boom 10 further allows the operator to change out different length counter-weight sections 26 thereby changing the length and load capacity of the boom 20. Similarly, a telescopic joint 265 fitted into counter-weight section 26 allows the length of a boom 20 to be varied to meet the operational requirements of a confined space.

Referring to FIGS. 1 through 6, wheel assembly 30 is shown to be a bi-pod or A-frame arrangement including an axle 32 attached to the remote ends of a pair of struts 31. A cross bar 34 above and parallel to the axle 32 is connected to one end of a support 35. The other end of support 35 is connected to either mid-section 24 or counter-weight section 26. It has been discovered that this arrangement increases the rigidity of the portable crane 10. It is further contemplated, but not shown, that additional wheels 33 can be added to axle 32 to increase the load bearing surface of the portable crane 10 upon the flat surface.

Referring to FIGS. 2 and 4 through 6, another portable crane 10 embodiment includes a wheel assembly 30 that is removably fixed to a mid-section 24 by a pin 242 and hole 243 arrangement similar to the arrangement used to connect a load section 22 to a mid-section 24 and a counter-weight section 26 to a mid-section 24. Such removable fixation enhances the ease of transporting a the portable crane 10. It further gives the operator the choice to select a wheel 33 configuration that is most suitable for the task at hand. As shown in all the figures, wheels 33 are fixed in a bi-pod arrangement. But it is further contemplated as yet another embodiment, but not shown, that a wheel assembly 30 includes a stop wheel. A stop wheel is positioned slightly above the pair of wheels 33 to engage the flat surface only just before the elevation of sheave 222 is slightly lower than the elevation of the operator seat 50. In yet another embodiment not shown, a pair of stop wheels are positioned in line with and slightly above the pair of wheels 33 to engage the flat surface as described above. Such stop wheel arrangements prevent or at least reduce catapulting an operator out of a seat if the load suddenly exceeds the counter-weight force of the boom 20.

Furthermore, the height of a boom 20 (its sheave 222 or operator seat 50) above the flat surface can be varied by using interchangeable wheel assemblies 30 with different ground clearances. This can be achieved by using wheels 33 of different diameters or altering the length of struts 31. Furthermore, the length of a strut 31 can be altered by including a telescopic joint within its length. All of the above are especially useful for operators with differing leg lengths.

It is further contemplated that wheel assembly 30 can be removably fixed at different positions along boom 20 with similar pin 242 and hole 243 arrangements as described above. (See FIGS. 2 and 5). Such positioning along the length of a boom 20 requires a corresponding number of attachment points to be formed in counter-weight section 26 to connect a support 35. In one embodiment, a plurality of holes 243 is formed in a rail 263 fixed to the bottom of counter-weight section 26 (See FIGS. 2 and 5). In another embodiment, not shown, with a plurality of holes 243 are formed in counter-weight section 26. In yet another embodiment not shown, a plurality of pins 242 are fixed to and extend away from the bottom of counter-weight section 26. While not shown, a portable crane 10 can include a support 35 with a telescopic joint along its length. Such multiple attachment points along either mid-section 24 or counter-weight section 26 (shown in FIGS. 2, 4 and 5) or a telescopic support 35 further allows an operator to alter the angle formed between a boom 20 and wheel assembly 30.

An operator seat 50 is fixed to boom 20. (See FIG. 1) In another embodiment, operator seat 50 can be removable (See FIGS. 4 and 6). As shown in FIGS. 3 and 5, operator seat 50 can be adjusted to a pre-set or operator defined position along boom 20.

A winch 40 with a rotatable drum 42 is fixed to boom 20. (See FIG. 1). Winch 40 can have a horizontal drum 42 as shown in all figures or a vertical drum 42 not show. It is further contemplated that drum 42 is operated by hand or by an operator controlled power source, like an electric motor (not shown). It is further contemplated that drum 40 can be configured to hold in one direction of rotation or allowed to rotate in both directions. To prevent wire 44 from jumping out of sheave 222, a guard 221 is fixed to the load boom section 22.

To further prevent operator mishaps, an embodiment of portable crane 10 includes operator controlled wheel brakes to prevent the wheels 33 from turning. Another safety feature contemplated is a lanyard that attaches to the counter-weight section 26 of a boom 20 and an adjacent immovable object, like a pipe stanchion, post or chimney.

The portable crane 10 described above can be manufactured out of steel, aluminum, wood, fiberglass, composite material or a combination thereof. The cross section of a boom 20 can be solid, hollow, circular, arcuate, rectangular, polygonal or any combination thereof. Wheels 33 can be solid or pneumatic.

These and other variations which will be appreciated by those skilled in the art are within the intended scope of this invention as claimed below. As previously stated, detailed embodiments of the present invention are disclosed herein; however, it is to be understood that the disclosed embodiments are merely exemplary of the invention that may be embodied in various forms.

What is claimed and desired to be secured by Letters Patent is as follows:

1. A portable crane comprising:
a boom with a mid-section disposed between a load section and a counter-weight section;
an operator seat assembly connected to said counter-weight section;
a sheave fixed to said load section;
a winch with a rotatable and lockable drum, said winch fixed to said boom;
a wire with two ends, said wire spooled on said drum with said first end securely attached to said winch and said second end fairlead over said sheave and attached to a lifting device; and
a wheel assembly connected to and below said mid-section, said wheel assembly comprising an axle perpendicular to said boom and having at least one pair of wheels in rolling contact with a flat surface.

2. A portable crane as claimed in claim 1, wherein said load section is removably fixed to said mid section by a first securing pin removably fixed through a first pair of aligned holes formed in adjacent regions of said load section and said mid-section, said first pair of aligned holes being distal to said counter-weight section.

3. A portable crane as claimed in claim 1, wherein said load section comprises a telescopic joint to releaseably fix said load section to a desired length.

4. A portable crane as claimed in claim 1, wherein said counter-weight section is removably fixed to said mid-section by a second securing pin removably fixed through a second pair of aligned holes formed in adjacent regions of said load section and said mid-section, said second pair of aligned holes being distal to said load section.

5. A portable crane as claimed in claim 1, wherein said counter-weight section comprises a telescopic joint to releaseably fix said counter-weight section to a desired length.

6. A portable crane as claimed in claim 1, wherein said wheel assembly is removably fixed to said mid-section by a third securing pin removably fixed through a third pair of aligned holes formed in adjacent regions of said of wheel assembly and said mid-section, said third pair of aligned holes being disposed between said first and second pair of aligned holes.

7. A portable crane as claimed in claim 1, wherein a stop wheel is fixed to said wheel assembly slightly above said pair of wheels to engage the flat surface only just before the elevation of said sheave is slightly lower than the elevation of said operator seat.

8. A portable crane as claimed in claim 1, wherein a variable length pair of struts comprising a releaseable telescopic joint between their respective ends are adjustably fixed between said axle and said mid-section.

9. A portable crane as claimed in claim 1, wherein a support is fixed between said wheel assembly and said boom.

10. A portable crane as claimed in claim 1, wherein a support is removably fixed between said wheel assembly and said boom, said support removably fixed to said boom by a securing post fixed to and extending down from said boom and through a hole formed in an upper part of said support.

11. A portable crane as claimed in claim 1, wherein a variable length support comprising a releaseable telescopic joint between its ends is adjustably fixed between said wheel assembly and said boom.

12. A portable crane as claimed in claim 1, wherein said operator seat assembly is removably fixed to said counter-weight section by a fourth securing pin removably fixed through a fourth pair of aligned holes formed in adjacent regions of said counter-weight section and said operator seat assembly.

13. A portable crane as claimed in claim 1, wherein said operator seat assembly is adjustably fixed to said counter-weight section.

14. A portable crane comprising:
a load boom section removably fixed to and extending away from a mid-section boom;
a sheave fixed to said load boom section distal to said mid-section boom;
a counter-weight boom section removably fixed to said mid-section boom and extending away from said load boom section;
an operator seat assembly removably fixed to said counter-weight boom section;
a winch assembly removably fixed to said counter-weight boom section between said mid-section boom and said operator seat assembly, said winch assembly comprising a drum of wire with two ends, said first wire end securely attached to said drum, said wire leading over said sheave and said second end securely fixed to a lifting apparatus;
a wheel assembly removably fixed to said mid-section boom, wherein said wheel assembly comprises a pair of struts and a cross bar joined to form an A-frame extending down and away from said mid-section boom, an axle attached to said pair of struts below and parallel to said cross bar, a pair of wheels rotatably attached to said axle, and a support removably fixed between said cross bar and said mid-section boom.

15. A portable boom as claimed in claim 14, wherein an additional wheel is rotatably attached to said axle.

16. A portable boom as claimed in claim 14, wherein said wire is lead through a guard attached to said load boom section.

17. A portable boom as claimed in claim 14, wherein operator actuated brakes are fitted to said wheels.

18. A portable boom as claimed in claim 14, wherein a lanyard is fixed between said counter-weight boom section and an adjacent immovable object.
